(19) United States
(12) Patent Application Publication
(10) Pub. No.: US 2010/0225966 A1
(43) Pub. Date: Sep. 9, 2010

(54) SYSTEM AND METHOD FOR PRINTING USING A DOCUMENT CONVERSION SERVER

(75) Inventors: Martin Bailey, Cambridge (GB); James Freidah, Centreville, VA (US)

Correspondence Address: FROMMER LAWRENCE & HAUG, 745 FIFTH AVENUE- 10TH FL., NEW YORK, NY, 10151, US

(73) Assignee: Global Graphics Software Limited, Cambridge (GB)

(21) Appl. No.: 12/717,339

(22) Filed: Mar. 4, 2010

Related U.S. Application Data
(60) Provisional application No. 61/157,413, filed on Mar. 4, 2009.

(51) Int. Cl. G06F 15/00

(52) U.S. Cl. 358/1.15

(57) ABSTRACT

A method of printing a document includes receiving a document at a printer; determining that a file format of the document is not supported by the printer; delivering the document to a document conversion server that is remote from, but coupled to, the printer; converting the document into a converted file format that is supported by the printer using the document conversion server; and delivering the document in the converted file format to the printer.

### CROSS-REFERENCE TO RELATED APPLICATIONS

This application claims the benefit under 35 U.S.C. §119(e) of U.S. Provisional Patent Application Ser. No. 61/157,413 filed on Mar. 4, 2009, which is incorporated herein by reference.

### FIELD

The present inventions are directed to the area of networks, printers, printed documents, and printer software and hardware, as well as to methods of printing. In addition, the present invention is directed to systems for printing documents that incorporate networked document conversion servers.

### BACKGROUND

Over the last few years it has become increasingly common for home and office printers to include interfaces allowing various forms of portable storage devices to be plugged in so that files on those devices can be printed. These devices are currently usually based on flash memory; in the future similar functionality may be provided using alternative technologies.

Provision of such sockets started primarily on home photo printers, supporting Secure Digital (SD), Memory Sticks (MS) and Compact Flash (CF) cards amongst others, and being able to print JPEG image files from those cards. Over time support for more portable storage device types have been added in devices, including USB sockets for USB flash drives (also known as “USB sticks”, “thumb drives” and “key drives”). In addition, printers have started to be able to print more file formats from portable storage devices, for example, camera raw formats and Adobe's Portable Document Format (PDF). Also, the ability to connect portable storage devices has expanded out from the home photo printer market into SOHO (small office, home office) printers and multi-function devices (MFPs).

The list of file types supported by each printer and MFP is, however, limited because each must include the software to parse and render each file type. While some printers in office environments are starting to accept a limited set of document formats, primarily PDF, it is confusing for users that other common document exchange formats are not supported.

In parallel with this there has been an increasing use of connected mobile devices, mainly as personal digital assistants (PDAs) with some form of network connection, or as smart phones. This leads to a desire to print documents from that mobile device, whether they have been received as attachments to email, downloaded from the internet, or obtained through some other route.

The user may be able to save the document as a file on a removable flash memory device in the phone (MS, micro-SD etc), which may be inserted into the printer. Alternatively there are now a number of printers and mobile devices that support printing from the device to a printer, usually using a combination of XHTML content, transmitted wirelessly over BlueTooth. In order to print a wide variety of document types, however, the mobile device must include the software to perform the document conversion from the original format into XHTML. The power and resources available in mobile devices has risen dramatically over the last few years, but still fall short of enabling a truly rich set of conversions. Thus the user will often find that they cannot print the file without resorting to some other (often more expensive or more circuitous) method.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic diagram of one embodiment of a network and devices coupled to the network, according to the invention; and

FIG. 2 is a flowchart of one method of printing a document, according to the invention.

### DETAILED DESCRIPTION

The present inventions are directed to the area of networks, printers, printed documents, and printer software and hardware, as well as to methods of printing. In addition, the present invention is directed to systems for printing documents that incorporate networked document conversion servers. It will be understood that documents are stored electronically as files and the terms “document” and “file” may be used interchangeably herein unless indicated otherwise.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The methods described herein can be performed using any type of computing device, such as a computer or printer, that includes a processor or any combination of computing devices where each device performs at least part of the process.

Suitable computing and printer devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

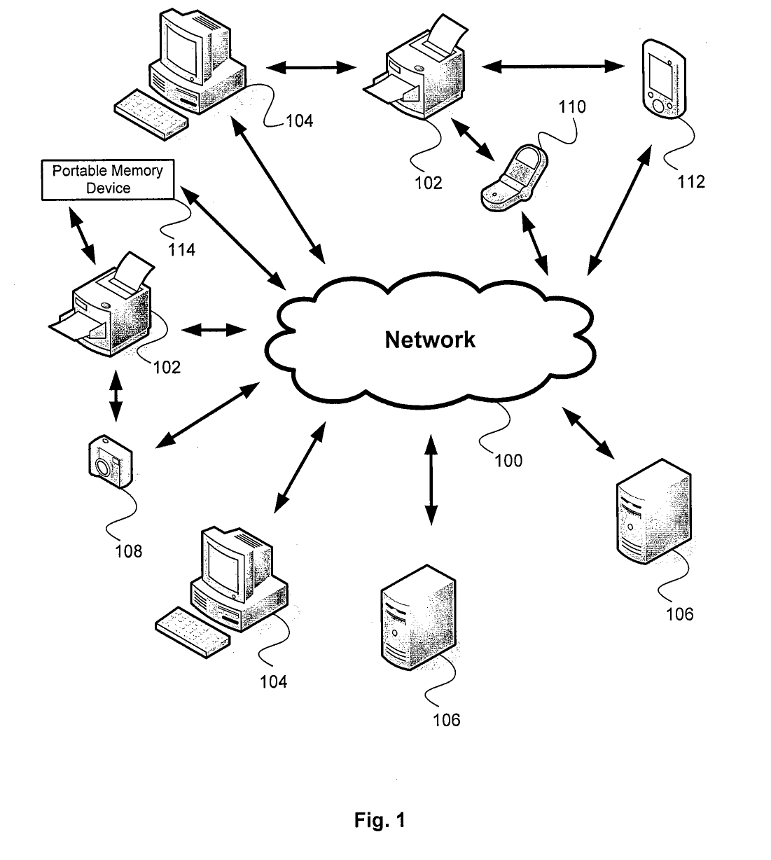

FIG. 1 illustrates one embodiment of a network environment. It will be understood that the network environment can be a local area network, a wide area network, or any combination thereof. It will also be understood that the network can include devices, other than those illustrated, coupled to the network and that there may be multiple devices of each type illustrated connected to the network. The environment includes a network 100 to which is attached, either directly or through other devices, one or more printers 102, one or more computing devices 104 (e.g., computers, workstations, and the like), and one or more servers 106 at least one of which is a document conversion server. Other devices can optionally be attached to the network such as cameras 108, cellular telephones 110, personal data assistants (PDA's) 112, portable storage devices 114 (e.g., compact discs, DVDs, memory sticks, flash drives, or other optical or magnetic storage media), and the like. Any of these devices can be connected directly to the network or via another device such as a computing device 104, printer 102, or server 106.

It will be recognized that more than one printer can be associated with each document conversion server. It will also be recognized that each printer can be associated with one document conversion server or multiple document conversion servers.

This invention addresses the inability of a specific printer to print a wide range of different document formats, for example, those formats provided direct from a portable storage device (e.g., memory stick, diskette, CD-ROM, DVD, flash memory, or the like) or mobile device (e.g., camera, cellular telephone, pda, or the like).

One or more document conversion servers are instantiated. One embodiment of a document conversion server takes the form of software running on a computer. The document conversion server typically which includes at least the following components: 1) a communications module, designed to enable bi-directional data exchange with a printer; and 2) software capable of accepting a number of file formats and converting them to other formats.

Each printer also contains a communications module, as software or firmware (or any combination thereof) on the printer which is capable of using the printer's network interface to transmit data to, and receive data from a document conversion server. The communications module in each printer is configured to contact one or more document conversion servers. Configuration may be performed in a variety of ways, including: 1) manually (e.g. through a user interface); 2) programmatically (e.g. using commands from a centralised printer management system); 3) automatically (e.g. by searching the local area network for servers); 4) by hard-wired connection (e.g. built into the device when shipped); or 5) any combination of these configuration methods.

In at least some embodiments each printer is configured to query the one or more document conversion servers from time to time to determine what file formats it can accept, and what output (print) formats it can produce. In different embodiments this polling may be performed at one or more of the following occasions: a) when the printer is turned on or reset; b) at a regular period, e.g. every hour, every day at 5 am, or every week; c) when a user attempts to print a document (for example, from a portable memory device or mobile device) and where the format of that document does not appear to be supported by the printer itself or by any associated document conversion server; d) when a printer attempts to communicate with a different document conversion server and the communication link cannot be established (e.g. because the server is not running, or can no longer be reached across the network).

In at least one embodiment, when polling the document conversion server each printer supplies a small amount of data about itself, including network address and the file format(s) that it can accept for printing. In response, the document conversion server responds with a list of the file formats that it is capable of converting to one or more of the formats supported by the printer. In addition, for each of those supported formats, it provides a mechanism for the printer to determine whether a supplied document is stored in that format. In at least one embodiment, this determination mechanism may be a list of the file name extensions usually used by that file format. In at least some embodiments, the identification method is provided as software; in such cases the document conversion server should be able to provide the software in a format that will run on the printer, using additional metadata from the printer in the initial request to identify the cpu type, operating system, and so forth that are used in the printer.

In at least some embodiments a document conversion server may state that it can determine file types automatically by reporting that it supports ‘all’ file formats.

In at least some embodiments, each document conversion server is instantiated to support whatever file formats make sense in the context of the environment in which the server is deployed. Thus a server in an architecture firm could support computer aided design (CAD) documents created using whatever CAD application is used by that firm, for instance.

In at least some embodiments, the printer maintains a record of the file types that may be submitted to each document conversion server.

In at least some embodiments, the document conversion server also provides additional metadata about itself to allow the printer to select a preferred server for document conversion. Such metadata could include conversion performance metrics, or server usage statistics. In addition, in at least some embodiments, the printer can measure additional metadata during the query process, including network latency and instantaneous transfer rate. The printer would then be able to select the fastest server available (taking into account both the server performance and the time required to transfer the document to and from the server), if desired. Alternatively the printer may elect to send a job to a more lightly loaded server even though it may be nominally slower.

In at least some embodiments, document conversion servers or printers (or both) can be configured to require secure authentication to ensure adequate security in their communication.

A user may request that the printer print a document in a number of different ways. For example, the user may request printing of a document by connecting a portable storage device on which the document is stored to an appropriate interface on the printer, and then by selecting the document for printing using a control panel on the printer. In this context, a mobile device may also function as a portable storage device if a storage area on the mobile device (RAM, flash memory card etc) can be mounted in a way that makes it accessible to the printer. Mounting in this way may be performed by connecting the mobile device to the printer using a cable, or by using a wireless protocol.

Another method for the user to request printing of a document is by connecting a mobile device to the printer either via a cable, or using a wireless protocol such as BlueTooth, and then by selecting the required document for print using a user interface on the mobile device, which transmits the selected document to the printer for printing, without converting the document from its original format into a specific format for the printer.

As an example of one embodiment of operation, when a user requests that a document be printed, the printer may perform several of the following operations. The printer examines the document to determine whether the printer supports the format natively. This determination may be by any method, such as reading the file name extension, analyzing the file content (e.g. by examination of the first few bytes of the file) or by speculative interpretation (if the interpretation succeeds, then the file format is supported.) If the file format is supported by the printer, then it processes the document.

If the file format is not supported by the printer directly, then it determines whether it is supported by one or more identified document servers. The printer can use metadata from exchanges with one or more document conversion servers to determine if each one can support the file format presented; this data may be cached from previous exchanges, or may be obtained when required from each server. If no document server is available that supports the file format directly, the printer can then determine if any document conversion server supports “all” file formats via automatic detection itself. If no document conversion servers are available to convert the required document, based on cached responses from previous exchanges with each server, the printer may query each server again to ensure that its information is up to date. If no document conversion servers are available to convert the required document, the printer will report that information to the user. The report may be via the user interface display, by printing a sheet of paper, etc.

If more than one document conversion server claims to be able to convert the document to a format supported by the printer, the printer may select one of those servers. The selection may be based on data supplied by one or more of the servers, on data collected about the network connection between printer and server, on the previous conversion success rate of each server etc. In some embodiments, however, the selection may be more or less random.

The printer will then send a request to the selected document conversion server to convert the supplied document. The request will contain the optimal file format required for the response. It may also contain a list of alternative formats that would be accepted. As part of the request, the document itself will be transmitted to the document conversion server. The document conversion server will attempt to convert the document as requested. In some embodiments and for some submitted file formats, the server will convert the document and start to return data to the printer before the whole document has been received by the server. In other embodiments, the document will be spooled to the server before conversion is started. A busy server may not be able to start conversion immediately, in which case the preferred embodiment will issue periodic status messages to the printer to keep the link between them alive.

If the document conversion server is successful, it will have returned the converted document to the printer and the printer will have printed it. If the document conversion server was not successful, and if the printer has access to additional servers, the printer can choose to send the document to an alternative server. If all available document conversion servers have tried to convert the document and failed, then the printer will report that information to the user. The report may be via the user interface display, by printing a sheet of paper, etc.

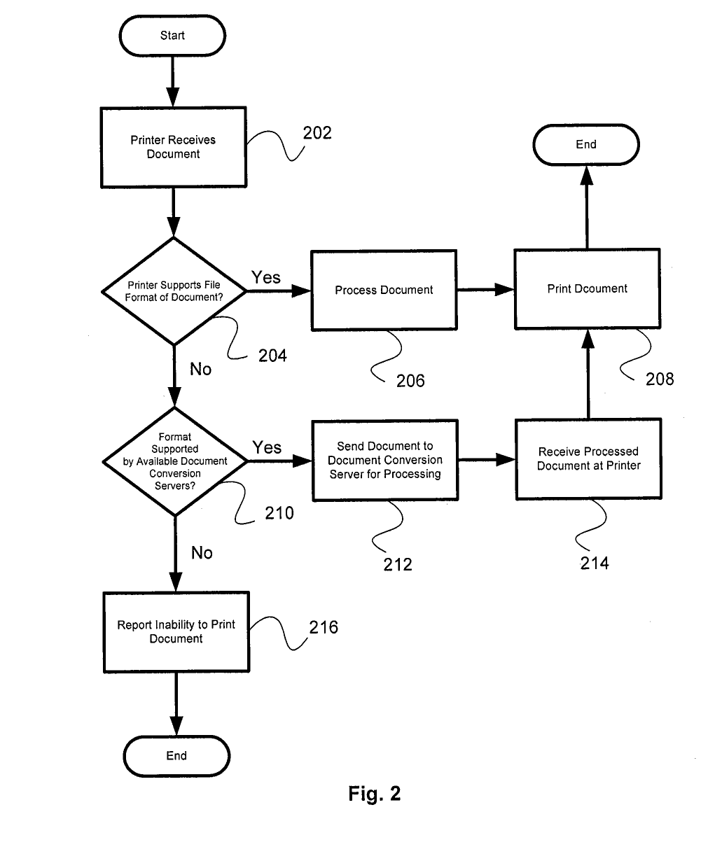

FIG. 2 is a flowchart illustrating one embodiment of a method of printing a document. The printer receives a document (step 202). The document may be received from a portable storage device, a mobile device (e.g., a cellular telephone, PDA, or camera), a computer, a server, or any other document source. The printer determines if the printer supports the file format of the document (step 204). If the printer supports the file format, the document is processed (step 206) and printed (step 208).

If the printer does not support the file format, the printer determines if there is an available document conversion server that can convert the file format (step 210). For example, the printer may refer to a list stored at the printer or elsewhere regarding file formats that can be converted by one or more document conversion servers; or the printer may query one or more document conversion servers to determine if one of the servers can convert the file format. If there is an available document conversion server to convert the document, the printer sends the document to the document conversion server for processing (step 212). The processed document, now in a file format supported by the printer, is sent back to the printer (step 214) and the document is printed (step 208). If there is no available document conversion server, then the inability to print the file is reported by the printer (step 216)

In at least some embodiments, the printer will expand the metadata it retains about each available document conversion server by analysis of the communication and success of each job submitted.

In at least some embodiments, the printer can request a unique identifier from the user (which may be credit card details, employee number, or the like) as part of the document submission process to enable fees for the conversion or print (or both) to be charged appropriately.

The document conversion server may be provided locally (e.g. within the local area network of a large organization's offices). This can enable easy provision of printer services for a hot-desking environment where employees require support services, but where they do not necessarily spend significant time in the same location and therefore may not have details of available local printers fully installed in their laptop computers, mobile devices etc.

Alternatively, the document conversion server can be provided remotely, possibly even by a third-party service organization. Such a remote service could be used to simplify the provision and servicing of print kiosks in environments such as hotel and conference facility business centers, airline lounges, etc. The fact that all communications between printer and server are initiated by the printer may avoid issues with firewalls, which in turn may remove at least some of the complexity in configuring individual printers because the installation technician does not need to know how to circumvent that firewall.

In addition, the inclusion of support for printing common document formats either within the printer itself or within a remote document conversion server or servers, preferably housed in a physically secure location, can assist in providing reliable tracking of print jobs if desired, and therefore robust charging of any fees that may be instantiated by the providers of the printer or of the document conversion server.

One particularly useful application is for business center printing in hotels, airports etc. Previously, such printing generally required additional hardware, most commonly a PC dedicated to the printer. Such PCs require considerable maintenance to ensure that the software used by the majority of clients is installed correctly on them, and that previous users have not amended the configuration in a way that makes printing difficult for later users. The systems and methods described herein provide printing without requiring the additional PC and, therefore, can avoid, at least in part, the need for that maintenance.

It will be understood that each block of the flowchart illustration in FIG. 2, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The computer program instructions, or portions of the computer program instructions, can be stored on any suitable computer-readable medium including, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of printing a document, the method comprising:
receiving a document at a printer;
determining that a file format of the document is not supported by the printer;
delivering the document to a document conversion server that is remote from, but coupled to, the printer;
converting the document into a converted file format that is supported by the printer using the document conversion server; and
delivering the document in the converted file format to the printer.

2. The method of claim 1, further comprising printing the document.

3. The method of claim 1, further comprising selecting the document conversion server from a plurality of available document conversion servers.

4. The method of claim 3, wherein selecting the document conversion server comprises maintaining a list of document conversion servers by the printer, wherein the list comprises a listing of file formats supported by each document conversion server.

5. The method of claim 3, further comprising requesting information from at least one document conversion server regarding file formats that can be converted by the document conversion server.

6. The method of claim 5, wherein requesting information comprises requesting information on a regular periodic basis from at least one document conversion server regarding file formats that can be converted by the document conversion server.

7. The method of claim 5, wherein requesting information comprises requesting information from at least one document conversion server regarding file formats that can be converted by the document conversion server when the printer determines that the printer does not support the file format of a received document.

8. The method of claim 5, wherein requesting information comprises requesting information from at least one document conversion server regarding file formats that can be converted by the document conversion server when the printer is turned on or reset.

9. The method of claim 1, wherein receiving a document comprises receiving a document from a mobile device.

10. The method of claim 1, wherein receiving a document comprises receiving a document from a portable storage device coupled to the printer.

11. A system for printing a document, the system comprising:
a printer;
a document conversion server coupled to the printer and remote from the printer;
at least one processor in communication with the printer; and
a computer readable storage medium having processor-executable instructions, the processor-executable instructions when installed onto the system enables the system to perform actions, comprising:
receiving a document at the printer,
determining that a file format of the document is not supported by the printer,
delivering the document to the document conversion server,
converting the document into a converted file format that is supported by the printer using the document conversion server, and
delivering the document in the converted file format to the printer.

12. The system of claim 11, wherein the system comprises a plurality of document conversion servers coupled to the printer.

13. The system of claim 11, wherein the document conversion server is coupled to the printer through a local area network.

14. The system of claim 11, wherein the document conversion server is coupled to the printer through a wide area network or the Internet.

15. The system of claim 11, further comprising a portable storage medium coupleable to the printer and containing the document.

16. The system of claim 11, further comprising a mobile device coupleable to the printer and containing the document.

17. The system of claim 11, wherein at least one of the at least one processors is disposed in the printer.

18. A computer readable storage medium having processor-executable instructions, the processor-executable instructions when installed onto a system enable the system to perform actions, comprising:
receiving a document at a printer;
determining that a file format of the document is not supported by the printer;
delivering the document to a document conversion server that is remote from, but coupled to, the printer;
converting the document into a converted file format that is supported by the printer using the document conversion server; and
delivering the document in the converted file format to the printer.

19. The computer readable storage medium of claim 18, wherein the processor-executable instruction enable the system to perform addition actions, comprising selecting the document conversion server from a plurality of available document conversion servers.

20. The computer readable storage medium of claim 19, wherein selecting the document conversion server comprises maintaining a list of document conversion servers by the printer, wherein the list comprises a listing of file formats supported by each document conversion server.
